(19) United States
(12) Patent Application Publication
(10) Pub. No.: US 2004/0122854 A1
(43) Pub. Date: Jun. 24, 2004

(54) System and method of personalizing an out-of-home experience

(76) Inventors: Michelle R. McKenna, Windermere, FL (US); Diane Schaffer, Orlando, FL (US); Sheila B. Jordan, Clermont, FL (US); Robert Dorsch, Orlando, FL (US); Thomas C. Boyles, Windermere, FL (US); Rick Betteridge, Orlando, FL (US); Chris Crayner, Windermere, FL (US); Gary Green, Clermont, FL (US); Bob Gibson, Lake Buena Vista, FL (US); Larry Roos, Orlando, FL (US); Mark Shafer, Orlando, FL (US); Ty Tastepe, Winter Garden, FL (US)

Correspondence Address: GREENBERG TRAURIG LLP, 2450 COLORADO AVENUE, SUITE 400E, SANTA MONICA, CA, 90404, US

(21) Appl. No.: 10/644,615

(22) Filed: Aug. 19, 2003

Related U.S. Application Data
(60) Provisional application No. 60/404,847, filed on Aug. 20, 2002.

(51) Int. Cl. G06F 17/00

(52) U.S. Cl. 707/103 R

(57) ABSTRACT

Customizing products and services offered by an out-of-home vacation provider to a customer's personal preferences includes creating a customer profile. Data about a customer's preferences is collected. The collected data is stored in the customer profile, and using a decision tree customizes the customer's vacation experience based on the collected data.

### RELATED APPLICATION

This application claims priority from provisional application 60/404,847 filed Aug. 20, 2002 and entitled System And Method Of Personalizing An Out-Of-Home Experience. The contents of that application are incorporated by reference herein.

### BACKGROUND

1. Field of the Invention

The present invention relates generally to out-of-home experiences, such as vacation planning. More specifically, the present invention relates to a system and method of customizing a customer's vacation experience.

2. Description of the Background Art

It is an object of the present invention to provide a system and method for providing a customized and personalized out-of-home experience, such as a vacation experience to customers.

### SUMMARY OF THE INVENTION

The present invention provides a unique system and method for out-of-home experiences such as vacation planning and thereby enhancing customer relations. The present invention acquires data about customers and combines real time customer and business information to use this information in novel ways. The system is preferably designed to focus the products and services of an out-of-home, preferably vacation provider to the profile of a vacationing customer.

In an exemplary form of the present invention, a customer arranges for a vacation by calling a toll free telephone number or other number where operators are available to help in the vacation planning process. The telephone operator has access to a computer system that accesses a database containing customer information. If the customer is new, the telephone operator enters as much information as they can collect regarding the customer.

The present invention provides a customized user interface for easily gathering relevant customer information. Relevant customer information may include, but is not limited to name, mailing address, email address, number of family members and approximate ages, travel interests, previous destination and accommodation information. If the customer has called before, or has previously planned a vacation, the operator should have access to information about their previous vacation or interests, allowing them to more effectively help the customer plan their next trip.

The system and method of the present invention is designed to match the profiles of customers with products and services offered. The system includes a dynamic recommender and packager. The system matches customer preferences and recommends what resort or hotel best matches those preferences and what type of vacation package is best for them. All preferences are saved and made available to other aspects of the system for future planning or marketing needs.

One unique aspect of the present invention is its pre-arrival communication stream. Various mailings, via regular mail, or email, are scheduled at pre-determined times leading up to the customer's planned vacation date. For example, tickets to attractions are scheduled to arrive approximately 40 days prior to the customer's vacation. Information related to their stay at the resort may be sent a few weeks prior to the vacation. Customized letters are generated based on customer information and sent to the customer to inform them of their vacation plans or otherwise inform them of events they may be interested in. The present invention incorporates an architecture consisting of 18 decision trees, which can generate over 1,500 possible customized letters.

The system of the present invention fully integrates out-of-home experiences such as vacation experiences by including flight, hotel, theme park admission, food, car rentals and other advantages of a vacation package.

In an embodiment of the present invention, records are kept related to a customer's behavior during a vacation experience, and used for planning future vacation experiences and better servicing of guests

An advantage of the present invention over prior art methods is that the present invention works to maintain customer relationships, and make customers want to keep coming back. Increased customer satisfaction and product relevancy means that customers will return more often. and share their experiences with friends and family.

The invention is now further described with reference to the accompanying drawings and description.

### BRIEF DESCRIPTION OF THE DRAWINGS

FIG. 1 is a conceptual outline of the integrated out-of-home experience, such as a vacation or entertainment package., and their related system enablers,

FIG. 2 is a screenshot showing the operator's ability to gather a guest's profile, find associated travel plans, and through a unique guest identifier identify the guest through CTI integration before answering the call.

FIGS. 3 & 4 are screenshots showing the operator's ability to discover the guest's particular travel interests FIG. 5 is a screenshot showing relevant offers to be presented to the guest based upon the discovery information—functionality behind the screen fits the guest's interests to the best resort, package and related availability.

FIG. 6 is a timeline indicating the proposed communication stream to enhance vacation and entertaining planning and the experience.

FIG. 7 is a flow chart for facilitating the communication of enhanced entertainment and vacation experience.

FIG. 8 is a conceptual representation of the architecture of the system.

FIG. 9 is a diagrammatic solution of a system and method of controlling the central reservation, property management and dining processes

FIG. 10 is a diagram of the application integration of the enterprise solution to illustrate how various users and applications integrate through an Enterprise Application Integration Hub

FIG. 11 is a representation of the data integration via a the Enterprise Application Hub illustrated in FIG. 10

FIG. 12 is a representation of the system and process integration to the requirements of the customer.

FIG. 13 is a glossary of terms and acronyms used in FIGS. 1-12.

### DESCRIPTION OF THE PREFERRED EMBODIMENTS

General

Customizing products and services offered by an out-of-home provider to a customer's personal preferences includes creating a customer profile and collecting data about a customer's preferences. The collected data is stored in the customer profile. A decision tree is used to customize the customer's out-of-home experience based on the collected data.

Preferably the out-of-home provider is a resort or entertainment operator. The customer preferences, customer profile and available facilities are integrated thereby to improve the out-of-home experience for customers and patrons of facilities out-of-home. Integrating the out-of-home provider facilities with desires of the customer, also matches the facilities with the desires of customers.

The customer profile is formed from data obtained from the customer, and preferably the customer is or will be a repeat user of one or more facilities of the operator.

Enhancing the match between the facility of the provider and the customer desires is effected by data obtained from historical records relating to preferences of the customer.

The integration affects a match between customer preferences of the future with the variety of vacation, accommodation, entertainment and travel packages available, preferably, as provided by the operator. Integration of itinerary, entitlements, customer profile, accounting, reporting, and pricing is effected.

The operator controls a data environment relating to the information of the customer, which is selectively a profile of the customer, including selectively family details, being selectively at least one of the size of the family, age of the family and preferences of the customer or family when they have an out-of-home experience.

The out-of-home experience includes at least one, and preferably several of travel mode, accommodation, entertainment or dining. The operator's data environment according to changes in the customer profile is dynamically updated, and the operator's database according to changes in available facilities is also dynamically updated.

There are at least two data environments, the first environment being a customer data environment and a second a products and services environment. Matching the data by a recommender algorithm is effected such that the customer's desires are strategically matched with the available services and products.

The customer profile includes an entry of the current bibliographical data of a customer, and relating current data to past bibliographical data. The requirements of the customer are selectively accessed by at least one of personal call, travel agent, group's sales or wholesalers.

Different databases include a customer profile database. There is an input for collecting data about a customer's preferences; and data storage for storing the collected data in the customer profile. Software algorithms include a decision tree to customize the customer's out-of-home experience based on the collected data; and a decision tree to uniquely identify guests across the enterprise

Software integrates the customer preferences, customer profile and available facilities thereby to improve the out-of-home experience for customers and patrons of facilities out-of-home. Software integrates the out-of-home provider facilities with desires of the customer, and matching the facilities with the desires of customers. The integration software affects a match between customer preferences of the future with a variety of vacation, accommodation, entertainment and travel packages available, preferably, as provided by the operator. The software matches the out-of-home experience including at least one of travel mode, accommodation, entertainment or dining. Also the software permits for dynamically changing the operator's database according to changes in the customer profile, and dynamically changing the operator's database according to changes available facilities.

There are at least two data environments, the first environment being a customer data environment and a second environment being a products and services environment. The software matches the data by a recommender algorithm such that the customer's desires are strategically matched with the available services and products. Components exist for integration of itinerary, entitlements, customer profile, accounting, reporting, and pricing. Other components exist for integrating the requirements of the customer, the customer selectively accessing the system by at least one of personal call, travel agent, groups sales or wholesalers.

Additionally, there is software for generating a time line for affecting a communication stream to a customer to enhance the out-of-home experience.

### DESCRIPTION IN RELATION TO FIGURES

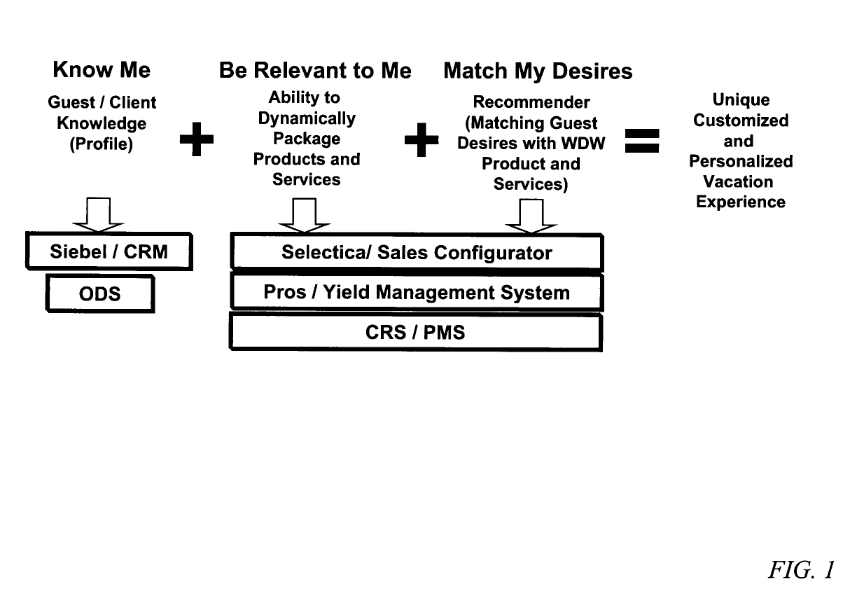

With the invented system as illustrated conceptually in FIG. 1, there are structures set up to enhance the entertainment and vacation experience of customers. The system is operated by a provider of vacations and entertainment. This can be a corporation managing entertainment and vacation facilities which could include theme parks, hotels, resorts, dining facilities, and travel facilities. With the invention, it is possible for such operator's to integrate enhance and match their facilities with the desires of customers. This is particularly improved where a customer is in the repeat user of the facilities of the operator. This enhancement arises because of the historical record of preferences of the customer.

Overall, the system and method of the invention provides for integration of the customers' preferences of the future with the best vacation, accommodation, entertainment and travel packages available as provided by the operator. The system provides for enhanced customer relevance and satisfaction and at the same time leads to more efficient implementation of the operator's facilities and thereby enhances the operator's business.

A business relationship is set up by the operator with the customers. The operator controls one or more databases relating to the information of the customer. A customer database can be a profile of the customer which can include family details, such as size of the family, ages of the family members and their overall preferences when they leave their home environment, for instance, for travel, entertainment or a vacation.

The operator's data environments can be dynamically changed according to changes in the customer or client profile or knowledge base. The operator also has a data environment for of products and services, namely travel, vacation, dining and other out-of-home experiences which could, for instance, include shopping benefits at facilities related to the operator. The products and services database is dynamically changeable as the operator varies the amount of the facilities and services that are available to customers.

The two data environments, namely the customer data environment and the products and services date environment are matched by a recommender algorithm such that the customers desires are strategically matched with the available services and products.

As such, the products and services are more tuned to particular customers and thereby the out-of-home experience is enhanced. This is beneficial both to the customer and to the operator, and there is a mutually enhanced satisfaction level which is achieved for them. The configured out-of-home experience is unique, customized and personalized for the customer. The operator achieves a better utility of its facilities and services.

Consumers have a robust interaction and access to information provided by the operator. Such access to information can be through the Internet and can be global. This means that customers in different continents can easily access facilities available by an operator in a different continents and can plan long-distance vacations and out-of-home experiences in a more hands-on personalized manner which is satisfying to consumers and the operator's. Consumers are thereby given relevant personalized choices and have more control over their customized out-of-home experience.

When a customer or client calls into the operator either by telephone or other telecommunication media such as through computerized input, the interaction, whether textual or oral, is focused on obtaining data from the customer or patron to build the profile of the customer or patron for the future. Customers or patrons are prompted to advise whether they are previous users of the operator's facility. Information is taken about the bibliographical detail of the customer, and information is given back to the customer by the operator relating to cost experiences with the operator. Generally the bibliographical detail of the proposed customer or operator is built up so as to facilitate the presently planned out-of-home experience and future out-of-home experiences.

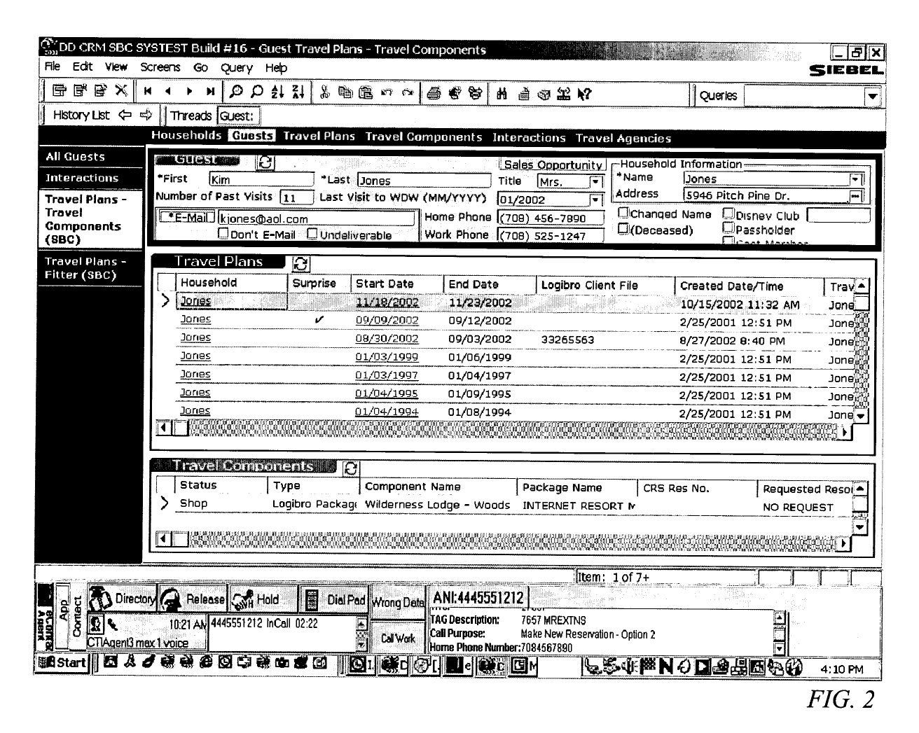

In FIG. 2 there is shown a screenshot which an operator has available so as to enter the current bibliographical data, and relate the data to past bibliographical data as may be necessary. This enhances the accuracy of the customer information in the customer database of the operator. It can provide for higher customer satisfaction and satisfaction of particular properties, resorts, hotels, and travel facilities provided by the operator. It can provide general cost savings, more focused to the unique requirements of customers, reduce possible cancellations, and enhance the utility and accommodation levels of the facilities of the operator. At the bottom of FIG. 2 computer telephony integration indicates caller's purpose and automatically presents the related guest profile to the operator before the call is answered.

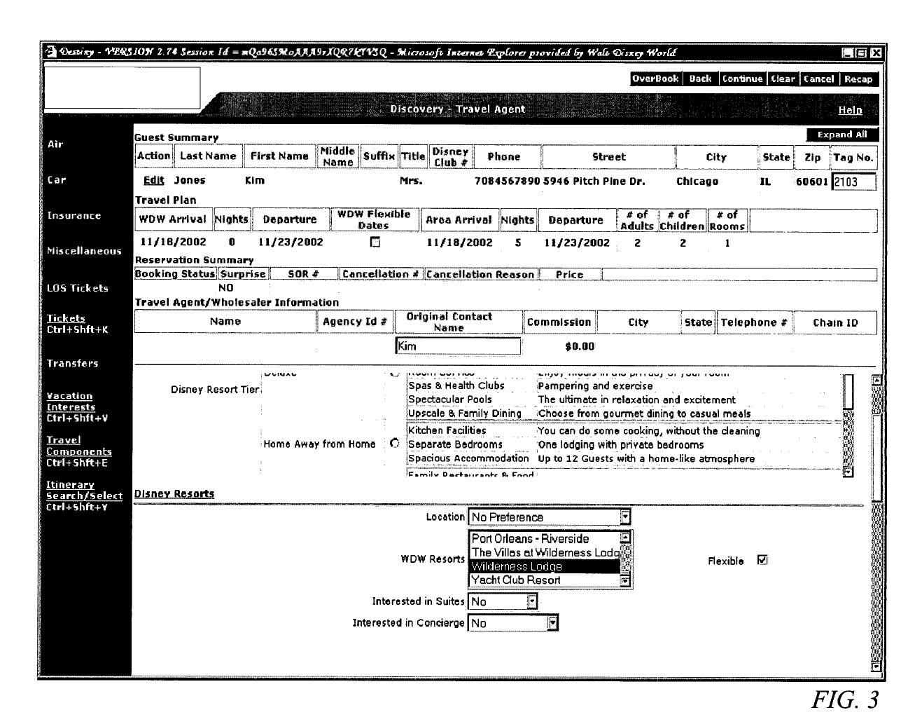

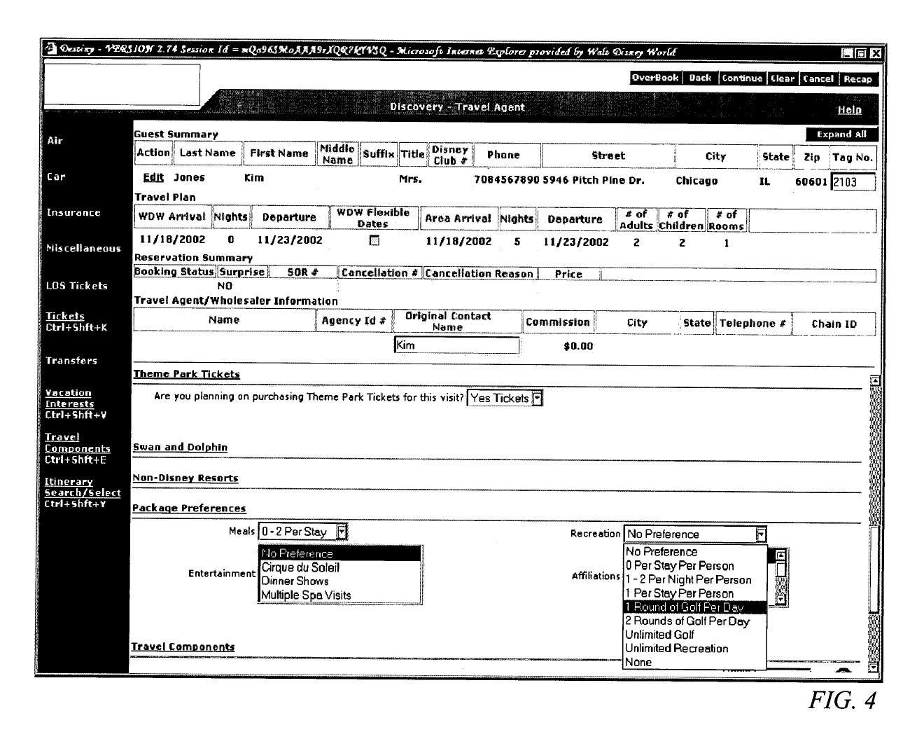

In FIGS. 3-4 there are screen shots relating a package system that enables an agent to enter customer preferences relative to resort accommodations, dining, recreation and entertainment activities all plans. The resort further takes the customer preferences relative to resort communities, location, dining types/styles and recreational activities available to determine the appropriate resort. This is an example of achieving an effective match between the facilities available by the operator and the desires of the customer or patron. The offer is subsequently presented as shown in FIG. 5.

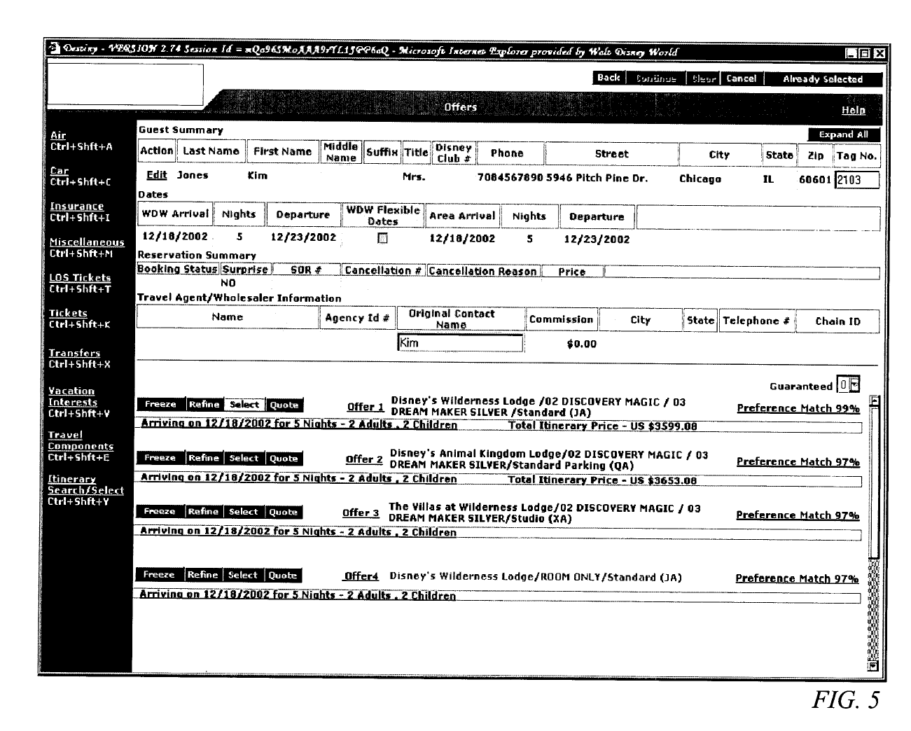

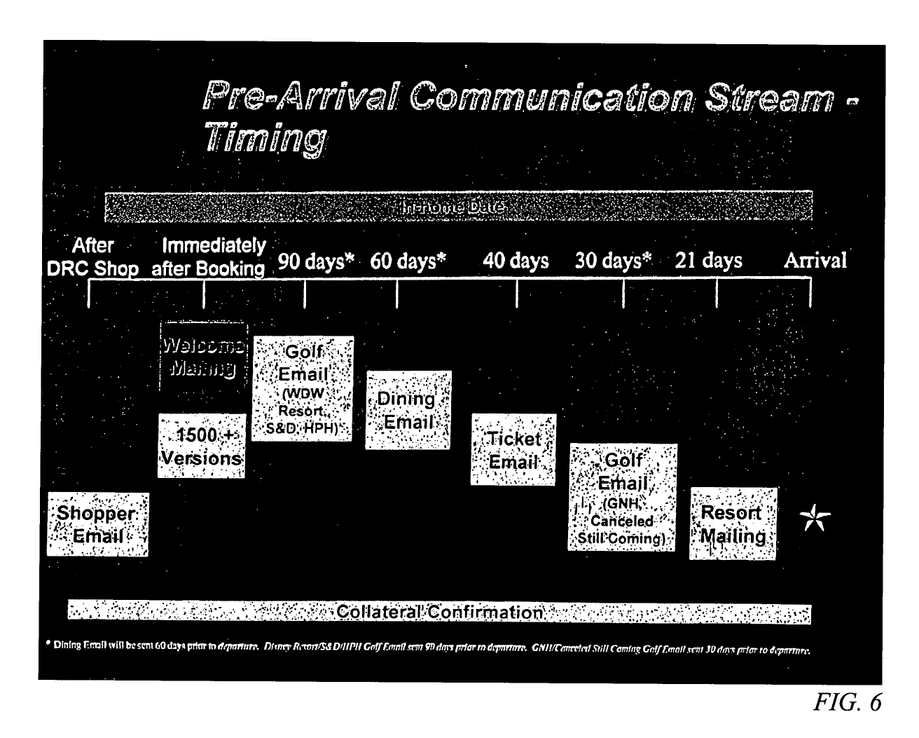

FIG. 6 there is shown a time-line of a communication stream intended to be sent by the operator or facilities under the control of the operator to a proposed customer. This time-line shows the delivery to the customer of facilities such as shopping information and tickets, welcoming information and tickets, golfing information and tickets, dining information and tickets, ticketing information, resort information and other supporting information and passes which could be used by the customer or patron in the upcoming out-of-home experience.

In FIG. 7 there is a flow diagram which illustrates concepts associated with the behavior patterns of the customer, setting up the life stage characteristics, namely related to the makeup of the family, and also the packaging criteria and communication needs to meet the life stage and behavior characteristics of the patron or patrons.

The system provides for computer telephony integration of multimedia contacts with a central reservation server. Also, other desktop applications for the purpose of enhancing customer interactions are provided, while at the same time reducing costs for the operator. The computer telephony integration enables further contact center evolution. As such separate data and voice infrastructures are set up, specialized agent groups manage different contact channels. The customer's stay and history is made available. This is accessible to a contact such that it is available on a desktop with the contact.

Contacts from a customer can be routed to the correct agent and contact center based on information gathering. This can be affected from the switch, namely the caller's phone number and the number dialed. This can be an Integrated Voice Response unit, which asks for the reservation number or a designated club number. The personal interactions with an agent can facilitate this, as well as a data environment that can identify the customer and then proide the customer profile and reservation history. Different pop-up screens utilize information from the switch or the voice response to the customer. Agent screens can be automatically populated with customer profile data and this can be sent to other regions. A seamless transfer of the data is set up to avoid requiring a customer repeat information to other regions. This enhances the customer experience with the system, and the contact types are blended, thereby increasing the smoothness of the operation. The different contact types can be e-mail, phone text chat. A contact log, and contact tracking database can be retained.

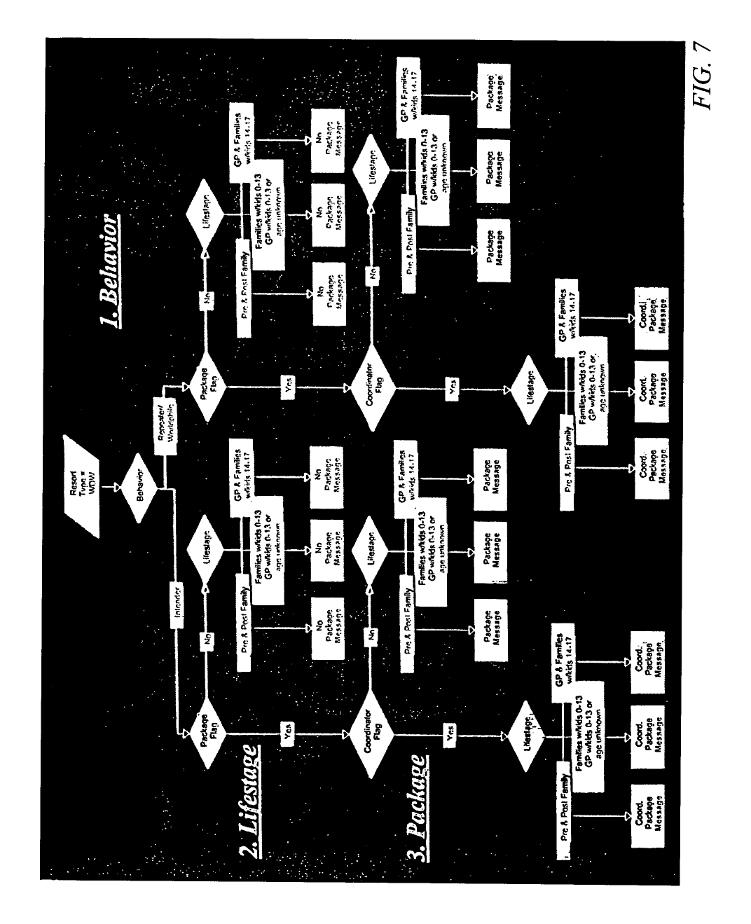

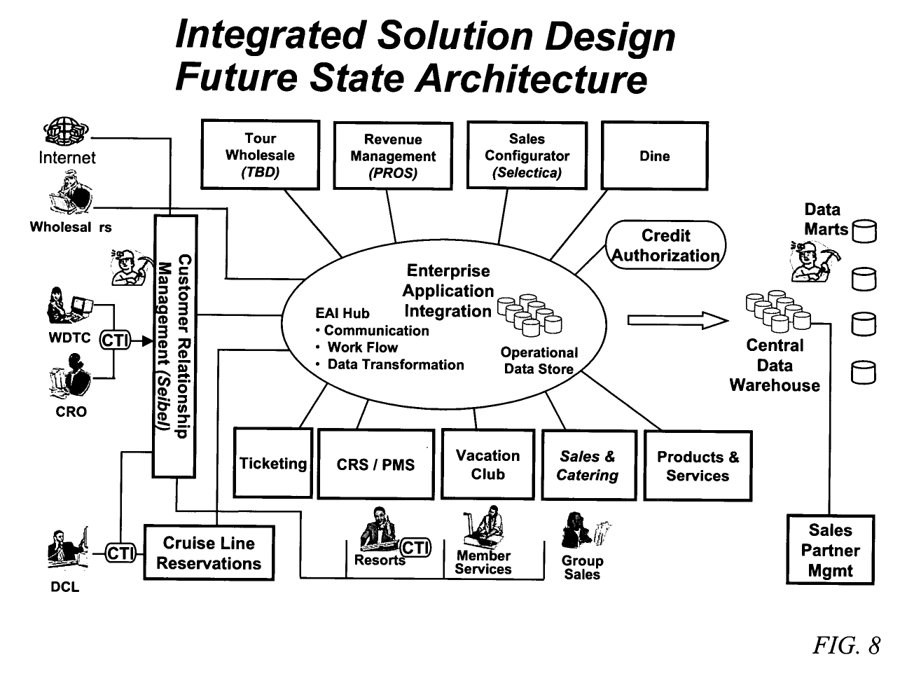

In FIG. 8 the integrated state architecture is illustrated in a conceptual manner. A hub system acts to integrate information from the operator's or providers with those seeking to make reservations in the out-of-home experience. The hub also provides the ability to effect ticketing and set up authorizations for accessing the purchased products and services from the appropriate fulfilling application. The hub communicates with an operational data store. Additionally, data from the central hub system is communicated to a central data warehouse, which can in turn be processed, mined or otherwise analyzed.

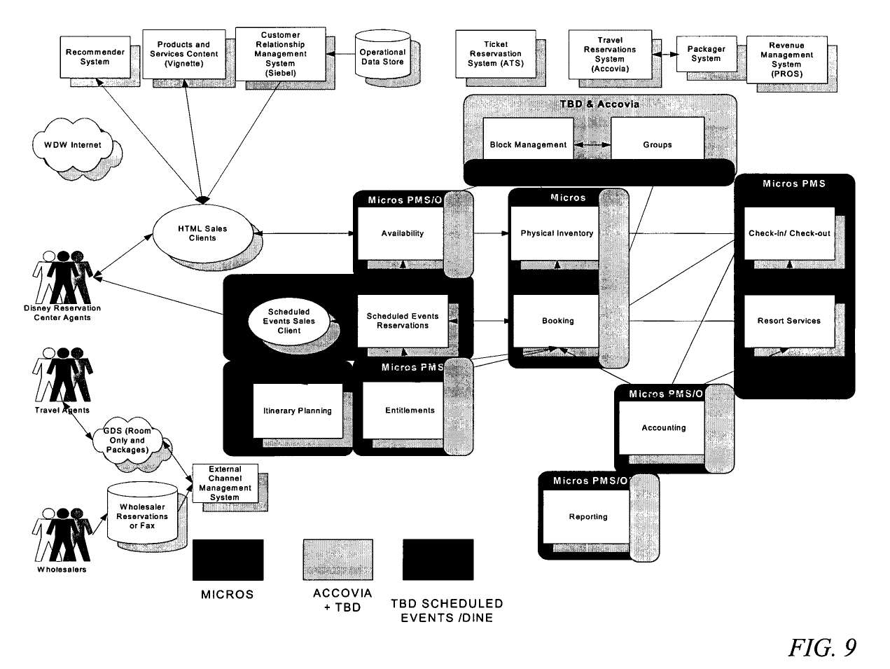

FIG. 9 illustrates the conceptual solution with the related applications of a central reservation, property management, dining, and scheduled events, provided by the operator. As can be seen on the left-hand side of this FIG. 9, HTML Sales Clients are used to connect the operator to the proper function residing in the back-end applications. In turn, HTML Sales Clients communicate with a system which controls the availability. The system itself is connected with any other system to schedule advance dining and other scheduled event entitlements. Block Management and Groups also communicate with the Physical Inventory and Booking modules and are connected with modules regulating the availability of facilities and bookings. Other modules relating to Reporting, Accounting, Check-in/Check-out and Resort Services are also appropriately linked into the system.

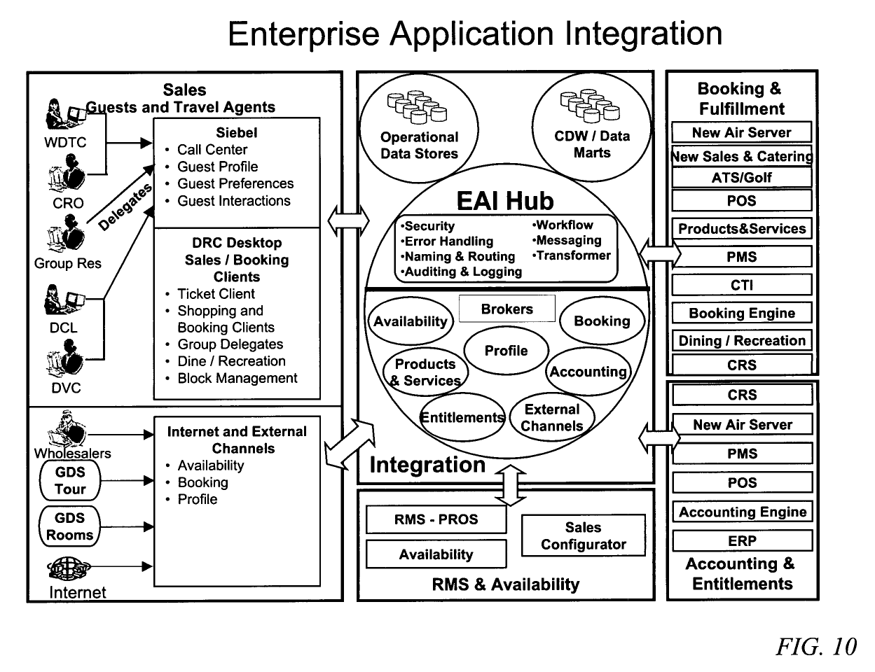

In FIG. 10 there is shown a representation of the application integration. The system hub integrates the information from other systems including the Sales module, the Resort Management System and Availability module, the Booking and Fulfillment module, and the Accounting an Entitlement modules. As can be seen in the Accounting and Entitlements module there is the ability to introduce additional facilities such as a New Air Server.

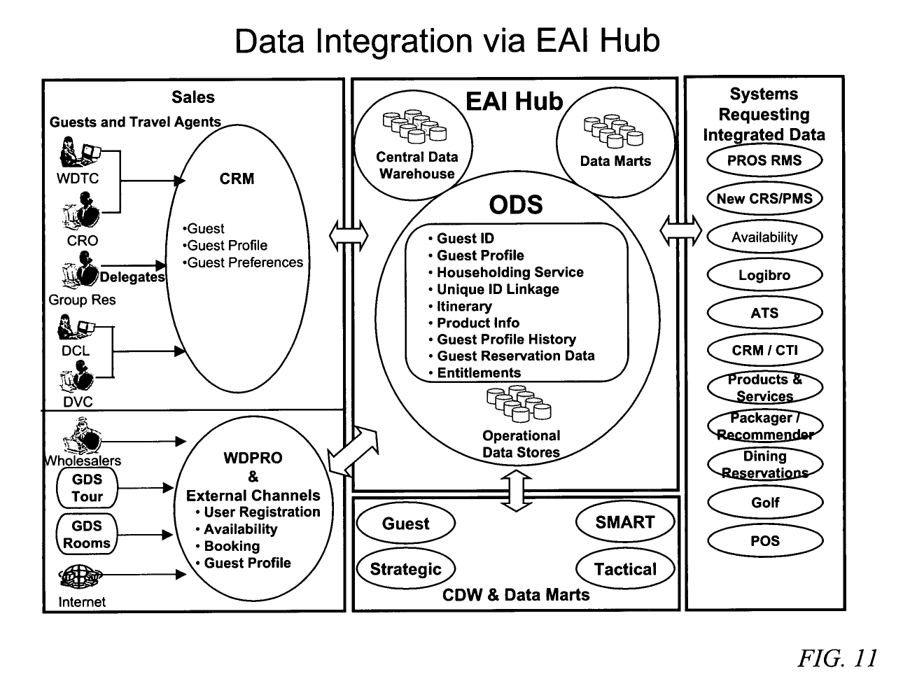

In FIG. 11 the data integration is represented. The hub system shows, for instance, the historical data related to the customer and the product information and entitlements. It also shows the capability to uniquely identify customers of the enterprise and make that data available to requested systems to aid in servicing the customer.

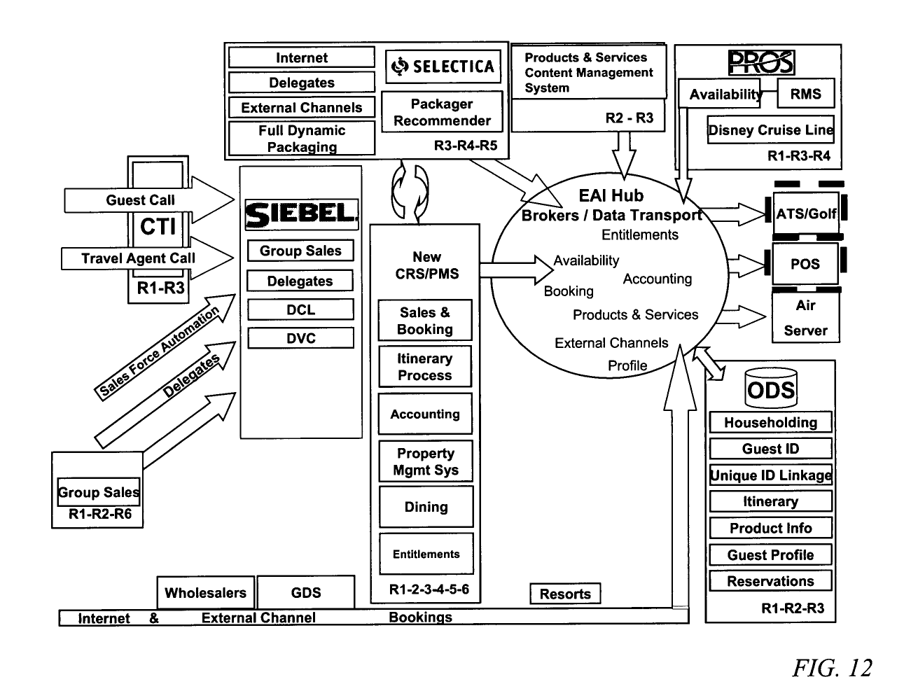

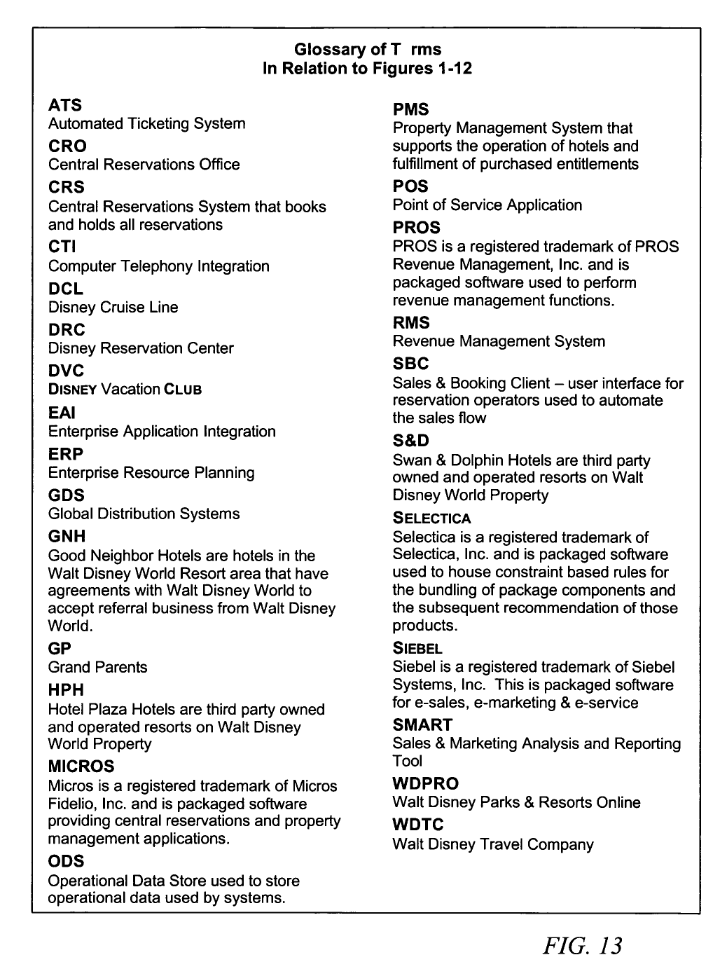

In FIG. 12 the process flow is show integrated with the various system providers of functionality. However the customer accesses the system whether by personal call, travel agent, groups sales or wholesalers, the data and related function is integrated across channels. Also shown is the different availabilities are from the out-of-home facilities and properties. Similarly the Packager Recommender software is connected with the system to optimize the experience with the availability of facilities and properties. Through all the centralized processing at the hub there is produced the out-of-home experience and access through the activities which would include travel, resort stay, entertainment and vacation products. The centralized system also permits for or facilitates communications to be made between the providers and the customers and patrons according to selected timetables.

General

While the exemplary embodiment relates to vacation planning, it is clear that the integrated system can be used for business planning, and for meeting scheduling and conference planning for organizations and groups. While the system is directed to managing the out-of-home and travel desires of customers and patrons, the focus is preferably centered on resort and entertainment properties and facilities. A provider often links these assets and there is the general necessity of efficiently operating results and entertainment facilities so as to maximize the use of these facilities by patrons. Similarly, there is a need to efficiently steer customers and patrons to underused facilities, properties and attractions so as to elevate their usage. For example this can be effected by providing customers with incentives such as discounts to attractions, resorts, or dining if the customer chooses particular products or services. The system thereby allows an operator of multiple properties to spread the load and occupancy around the properties to enhance revenue from the assets of the operator.

At the same time the system of the invention is directed to improving the loyalties and experiences that patrons have been using the facilities and properties are the provider. By factoring in a historical profile of customers and patrons the resort and entertainment centers can harmonize the desires of customers and patrons to facilities properties and experiences that are available to the customers, patrons, their families and extended families.

By increasing a brand loyalty and satisfying experience with the enhanced management of the customer at the operator's facility, the out-of-home experience improves and a better relationship is fostered between the provider and recipient. Directing promotional material to the customer at appropriate times before, during and after the out-of-home experience makes the total experience more satisfying for the customer. For instance, after a visit to a resort or entertainment center of the operator the customer can be provided with follow-up discount promotional material to revisit the resort or entertainment center at a later time. Additionally material can be offered and given to the customer as a token of appreciation.

By integrating the entire experience, for instance, a post out-of-home experience could be the reward of free dinners or the like that regular commercial establishments and preferably establishments related to the operator's of the resort or entertainment facilities.

An advantage of the invention is to provide for seamless or near seamless organization of the out-of-home experience for the customer. Details associated with the travel to and from resorts, hotels and entertainment centers are integrated into the planning and performance by the centralized hub system. The system provides for enhanced care of customers and nurtures their experience with the operator so that the likelihood of repeat business increases. The profiling permits for individual preferences of different customer members of a customer family to matched with available facilities of the provider according to the individual customer preferences. As such the family customer is provided with an enhanced and more satisfying service of different products and services that are available to suit individual needs of the customer family.

The provision of an integrated solution by incorporating different modules, namely the module of the central reservation system, the module of data gathering, and the module of property management to provide a seamless or near seamless system for a provider and hence for the benefit of customers is a significant advance in the technology and system of controlling the out-of-home experience of the customer.

The profiling permits for individual preferences of members of a family profile to be matched.

Descriptions of exemplary embodiments of the invention provided are one form of implementation. Other embodiments and implementation may be utilized and structural and functional changes may be made without departing from the respective scope of the present invention. The attached description of exemplary and anticipated embodiments of the invention have been presented for the purposes of illustration and description. They are not intended to be exhaustive or to limit the invention to the precise forms disclosed.

Many modifications and variations are possible in light of the teachings herein. Many other forms of the invention exist, each differing from the others in matters of detail only. The invention is to be determined by the following claims.

We claim:

1. A method of customizing products and services offered by an out-of-home provider to a customer's personal preferences, the method comprising:
creating a customer profile;
collecting data about a customer's preferences;
storing the collected data in the customer profile; and
using a decision tree to customize the customer's out-of-home experience based on the collected data.

2. A method as claimed in claim 1 wherein the out-of-home provider is a resort or entertainment operator.

3. A method as claimed in claim 1 including integrating the customer preferences, customer profile and available facilities thereby to improve the out-of-home experience for customers and patrons of facilities out-of-home.

4. A method as claimed in claim 1 including the steps of integrating the out-of-home provider facilities with desires of the customer, and matching the facilities with the desires of customers.

5. A method as claimed in claim 1 including the forming the customer profile from data obtained from the customer, the customer being a repeat user of one or more facilities of the operator.

6. A method as claimed in claim 1 including enhancing the match between the facility of the provider and the customer desires, the enhancement being effected by data obtained from historical records relating to preferences of the customer.

7. A method as claimed in claim 1 wherein integration affects a match between customer preferences of the future with the a variety of vacation, accommodation, entertainment and travel packages available, preferably, as provided by the operator.

8. A method as claimed in claim 1 including attaining an improved level of customer satisfaction and at the same time attaining and improved implementation of the operator's facilities thereby to enhance the operator's business.

9. A method as claimed in claim 1 wherein the operator controls a data environment relating to the information of the customer.

10. A method as claimed in claim 9 wherein such data environment is selectively a profile of the customer, including selectively family details, being selectively at least one of the size of the family, age of the family and preferences of the customer or family when they have an out-of-home experience.

11. A method as claimed in claim 1 wherein the out-of-home experience includes at least one of travel mode, accommodation, entertainment or dining.

12. A method as claimed in claim 1 wherein the out-of-home experience includes at least several of travel mode, accommodation, entertainment or dining.

13. A method as claimed in claim 1 including dynamically changing the operator's database according to changes in the customer profile.

14. A method as claimed in claim 1 including dynamically changing the operator's database according to changes available facilities.

15. A method as claimed in claim 13 including dynamically changing the operator's database according to changes available facilities.

16. A method as claimed in claim 1 wherein the operator operates a database of products and services, selectively including one or more of travel mode, vacation choice, entertainment choice and dining choice.

17. A method as claimed in claim 1 wherein there is at least two data environments, a first data environment being a customer data environment and a second data environment being of products and services, and including matching the data environments by a recommender algorithm such that the customers desires are strategically matched with the available services and products.

18. A method as claimed in claim 1 wherein the customer profile includes an entry of the current bibliographical data of a customer, and relating current data to past bibliographical data.

19. A method as claimed in claim 1 including creating an integration of itinerary, entitlements, customer profile, accounting, reporting, and pricing.

20. A method as claimed in claim 1 including integrating the requirements of the customer, the customer selectively accessing the system by at least one of personal call, travel agent, groups sales or wholesalers.

21. A method as claimed in claim 1 including generating a time line for affecting a communication stream to a customer to enhance the out-of-home experience.

22. A system of customizing products and services offered by an out-of-home provider to a customer's personal preferences, the system comprising:
a database of a customer profile;
an input for collecting data about a customer's preferences;
the data storage for storing the collected data in the customer profile; and
a software algorithm including a decision tree to customize the customer's out-of-home experience based on the collected data.

23. A system as claimed in claim 22 wherein the out-of-home provider is a resort or entertainment operator.

24. A system as claimed in claim 22 including software for integrating the customer preferences, customer profile and available facilities thereby to improve the out-of-home experience for customers and patrons of facilities out-of-home.

25. A system as claimed in claim 22 including software for integrating the out-of-home provider facilities with desires of the customer, and matching the facilities with the desires of customers.

26. A system as claimed in claim 22 including software for enhancing the match between the facility of the provider and the customer desires, the enhancement being effected by recommender integrator software applying data from historical records relating to preferences of the customer.

27. A system as claimed in claim 22 including into integration software for affecting a match between customer preferences of the future with the a variety of vacation, accommodation, entertainment and travel packages available, preferably, as provided by the operator.

28. A system as claimed in claim 22 wherein such database is selectively a profile of the customer, including selectively family details, being selectively at least one of the size of the family, age of the family and preferences of the customer or family when they have an out-of-home experience.

29. A system as claimed in claim 22 wherein the software matches the out-of-home experience including at least one of travel mode, accommodation, entertainment or dining.

30. A system as claimed in claim 22 wherein the software matches the out-of-home experience including at least several of travel mode, accommodation, entertainment or dining.

31. A system as claimed in claim 22 including software for dynamically changing the operator's database according to changes in the customer profile, and dynamically changing the operator's database according to changes available facilities.

32. A system as claimed in claim 22 wherein there is at least two data environments, a first data environment being a customer data environment and a second environment of products and services, and including software for matching the databases by a recommender algorithm such that the customers desires are strategically matched with the available services and products.

33. A system as claimed in claim 22 including components for integration of itinerary, entitlements, customer profile, accounting, reporting, and pricing.

34. A system as claimed in claim 22 including components for integrating the requirements of the customer, the customer selectively accessing the system by at least one of personal call, travel agent, groups sales or wholesalers.

35. A system as claimed in claim 22 including software for generating a time line for affecting a communication stream to a customer to enhance the out-of-home experience.
